(19) United States
(12) Patent Application Publication
(10) Pub. No.: US 2017/0126676 A1
(43) Pub. Date: May 4, 2017

(54) Protection of Content Displayed on a Communal Device

(71) Applicant: Microsoft Technology Licensing, LLC, Redmond, WA (US)

(72) Inventors: Phillip Dean Garding, North Bend, WA (US); Gregory Quinn Fix, Seattle, WA (US); Barnett Alexander Trzcinski, Seattle, WA (US); John Cole Bradley, Seattle, WA (US)

(21) Appl. No.: 14/928,396

(22) Filed: Oct. 30, 2015

(51) Int. Cl. H04L 29/06; G06F 21/60

(52) U.S. Cl. CPC H04L 63/0876; G06F 21/604; H04L 63/102

(57) ABSTRACT

Protecting content on a local device. A method includes, at a local device connecting to a remote server controlled meeting, wherein the remote server provides meeting content. The method further includes, at the local device, receiving meeting content from the remote server. The method further includes, at the local device preventing a user of the local device from accessing the meeting content. The method further includes, at the local device obtaining an authentication token. The method further includes, at the local device receiving from a user the obtained authentication token to authenticate the user to the device. The method further includes, at the local device, comparing the received token to the obtained token. The method further includes, as a result of the received token matching the obtained token, providing access to the meeting content to user.

### BACKGROUND

### Background and Relevant Art

Computers and computing systems have affected nearly every aspect of modern living. Computers are generally involved in work, recreation, healthcare, transportation, entertainment, household management, etc.

Further, computing system functionality can he enhanced by a computing system's ability to he interconnected to other computing systems via network connections. Network connections may include, but are not limited to, connections via wired or wireless Ethernet, cellular connections, or even computer to computer connections through serial, parallel, USB, or other connections. The connections allow a computing system to be used for virtual meetings. In particular different individuals can access computer systems at different locations and can participate in virtual meetings. The interconnected computer systems can share video data, voice data, and other content, such as whiteboards, documents, and a host of other content.

While often, users are able to use a personal computing system to access such meetings, there are also communal computing systems that users can use. For example, at an enterprise, a video conferencing room may have a communal device which includes computer hardware that can access virtual meetings. In such scenarios, typically the meeting organizer knows that certain meeting attendees will he attending the virtual meeting using a particular communal device. The meeting organizer will send a meeting invite to the communal device and include the communal device in a list of attendees allowed to attend the virtual meeting. Thus, when a user at the communal device requests that the communal device be allowed to join a meeting, the communal device will be admitted to the meeting.

Because meeting content is displayed on a communal device admitted to the meeting, it is possible that people who were not invited to join a meeting, can nonetheless access meeting content, by using the communal device.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method that may be practiced in a content sharing environment. The method includes acts for protecting content on a local device. The method includes, at the local device connecting to a remote server controlled meeting, wherein the remote server provides meeting content. The method further includes, at the local device, receiving meeting content from the remote server. The method further includes, at the local device preventing a user of the local device from accessing the meeting content. The method further includes, at the local device obtaining an authentication token. The method further includes, at the local device receiving from a user the obtained authentication token to authenticate the user to the device. The method further includes, at the local device, comparing the received token to the obtained token. The method further includes, as a result of the received token matching the obtained token, providing access to the meeting content to user.

Another embodiment includes a method practiced in a content sharing environment. The method includes acts for protecting content on a local device. The method includes at the local device connecting to a remote server controlled meeting, wherein the remote server provides meeting content. The method further includes, at the local device preventing a user of the local device from adding to the meeting content. The method further includes, at the local device obtaining an authentication token. The method farther includes, at the local device receiving from a user the obtained authentication token to authenticate the user to the device. The method further includes, at the local device, comparing the received token to the obtained token. The method further includes, as a result of the received token matching the obtained token, providing access to the user to allow the user to add to the meeting content.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter,

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an on-line meeting environment;

FIG. 2 illustrates another example of an on-line meeting environment;

FIG. 3A illustrates a content frame with a PIN keypad;

FIG. 3B illustrates the content frame with a list of meeting invitees;

FIG. 4 illustrates an example of an email for sending a token to a meeting invitee in a meeting invite;

FIG. 5 illustrates a method of a method of protecting content on a local communal device; and

FIG. 6 illustrates a method of a method of protecting content on a local communal device.

### DETAILED DESCRIPTION

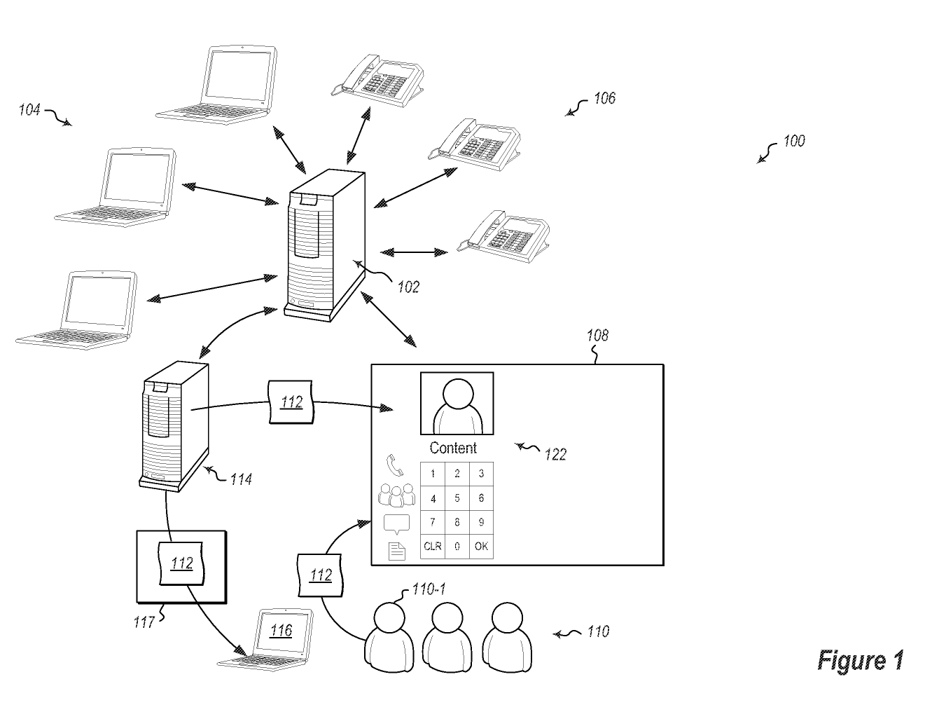

Referring now to FIG. 1, a content sharing environment 100 is illustrated. The content sharing environment includes an on-line remote server 102. The remote server 102 provides infrastructure for facilitating on-line meetings. For example, the remote server 102 may be a Skype For Business server available from Microsoft Corporation of Redmond, Wash.

Various different devices can connect to the remote server 102 for on-line meetings. For example, FIG. 1 illustrates a set 104 of personal computers. Each of the computers in the set 104 of personal computers may have client software installed on them to allow them to connect to the on-line meeting hosted by the remote server 102. FIG. 1 further illustrates a set 106 of telephones. Each of the telephones in the set 106 of telephones can connect to the on-line meeting hosted by the remote server 102 by calling into a telephone interface. Further, FIG. 1 illustrates a communal device 108. While a single communal device 108 is shown, it should be appreciated that multiple communal devices could be connected to the on-line meeting hosted by the remote server 102.

Typically, users are sent an invitation to an on-line meeting. The users can join the meeting by supplying the appropriate meeting identification included, in the invitation and, some type of authentication to authenticate the users to the remote server 102. Often, one or both of these can be provided simply by selecting a link in a meeting invite that includes a URL to the appropriate logical location at the remote server. However, when a communal device 108 is used, the communal device 108 is invited to the meeting and is authenticated to the remote server 102 instead of each of the users 110 at the communal device. Often, this is done by a user at the communal device 108 accessing a calendar at the communal device. The calendar includes entries for each meeting to which the communal device 108 has been invited. A user at the communal device 108 can simply select a meeting from the calendar to cause the communal device 108 to join the on-line meeting. Thus, while users are authenticated to the remote server 102 for users at computers in the set 104 of computers and users are authenticated to the remote server 102 for users at telephones in the set 106 of telephones, the communal device 108 itself is authenticated for a communal device 108. This results in a situation where non-invited users could use the communal device to join the on-line meeting hosted by the remote server 102.

In particular, when a communal device 108, such as the Surface Hub available from Microsoft Corporation of Redmond, Wash., is invited to join an on-line meeting (to allow users at the communal device to access the meeting) and when content is displayed on the communal device, it is possible for people who were not invited to join a meeting, to nonetheless use the communal device to view content intended for meeting recipients. As the content panel will display information that could be confidential, and additionally content from the calendar invite (which could also contain confidential information) could end up on the communal device, it may be desirable to control access to the content panel, and/or other content.

In some systems, if the meeting is locked, this can be done by causing the communal device 108 to wait in the lobby until someone, such as a meeting organizer that can verify that only authorized, individuals are at the communal device, explicitly allows the communal device 108 into the meeting. After the communal device 108 enters from the lobby, users 110 at the communal device 108 will have full access to the content panel and/or other content.

Alternatively, as illustrated by embodiments described herein, a user 110-1 who was invited to the meeting, and accesses the meeting using the communal device 108 provides an authentication token 112 at the communal device, such as by entering a PIN that she received in an email. In the illustrated examples, the communal device 108 can join the meeting and receive content, but will not display the content until the user 110-1 provides the authentication token 112. Thus, in this example, the user 110-1 provides an authentication token 112 to the communal device 108 where the communal device 108 controls access to content as opposed to the server 102 controlling access to the content with respect to users 110 that access the content at the communal device.

There are various ways for the user 110-1 to receive an authentication token 112. For example, a user could receive the authentication token 112 via email, such as in a calendar invite to an on-line meeting or in email at the time of the meeting. For example, FIG. 1 illustrates an example where a mail server 114 sends the token 112 to a computing system 116 that is used by the user 110-1. In particular, the Token 112 may be included in a calendar invite 117 sent from the mail server 114 inviting the user 110-1 to the on-line meeting hosted by the remote server 102. Note that the remote server 102 is coupled to the mail server 114 so that the mail server 114 can schedule the meeting on the remote server 102.

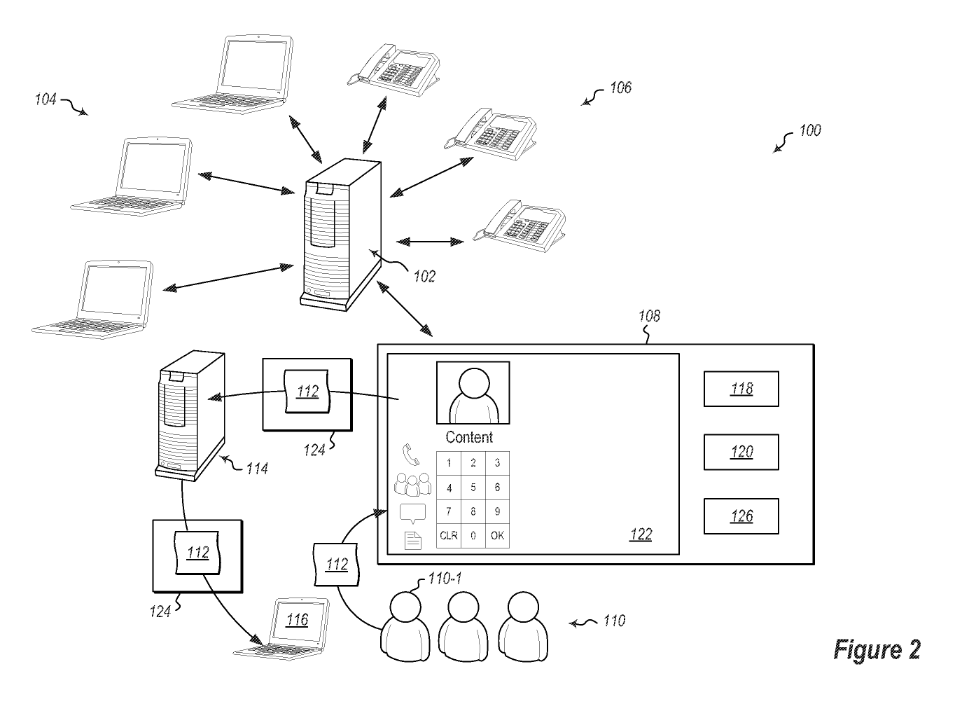

Alternatively, as illustrated in FIG. 2, the communal device 108 may include functionality, such as a token generator 118 for generating the authentication token 112 locally at the communal device. 108 and mailing the authentication token 112 to one or more users in a list of users that were invited to the on-line meeting. For example, the token generator 118 may be configured to generate tokens. Generating tokens may be performed by obtaining a random or pseudo number and operating on the random number to produce a token. Thus, for example, a random number generator that uses the system clock of the communal device 108 may be used to generate a random number. The random number can then be operated on, such as by truncating the number or transforming the number to produce the token.

In one example, to provide the token to the user 110-1, the communal device 108 may include an email client 120. The email client 120 can send the token 112 to the user 110-1 by sending the token to the mail server 114 in an email message 124 addressed to the user 110-1 such that the email server delivers the token in the email message 124 to the user's computing system 116. Note that in some such embodiments, a user at the communal device 108 will be presented with a list of users invited to the on-line meeting. The user can only select users from the presented list, after which the communal device 108 will send the authentication token 112 to the selected user. In this way, users will not be able to cause the communal device 108 to email the authentication token 112 to users who were not invited to the on-line meeting.

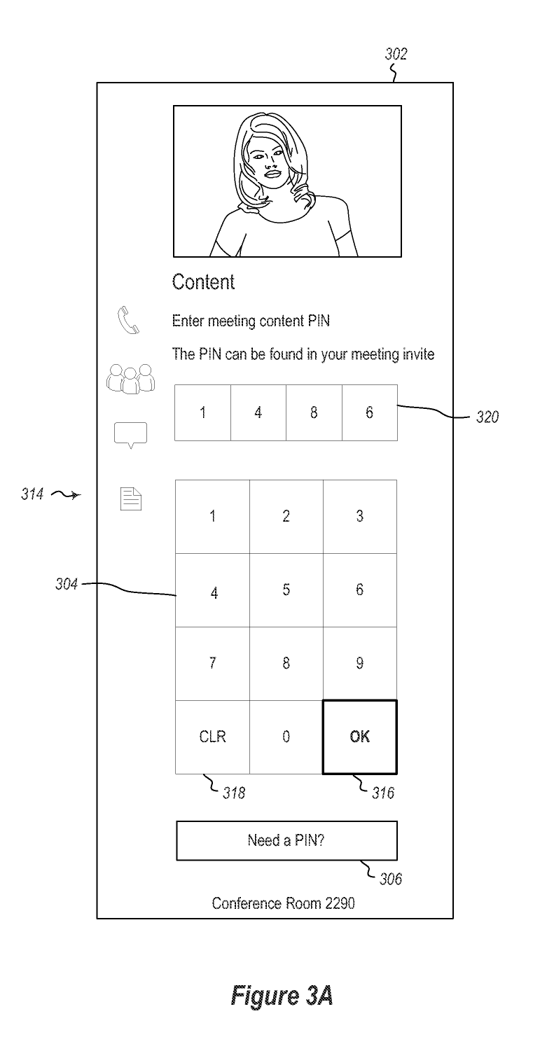

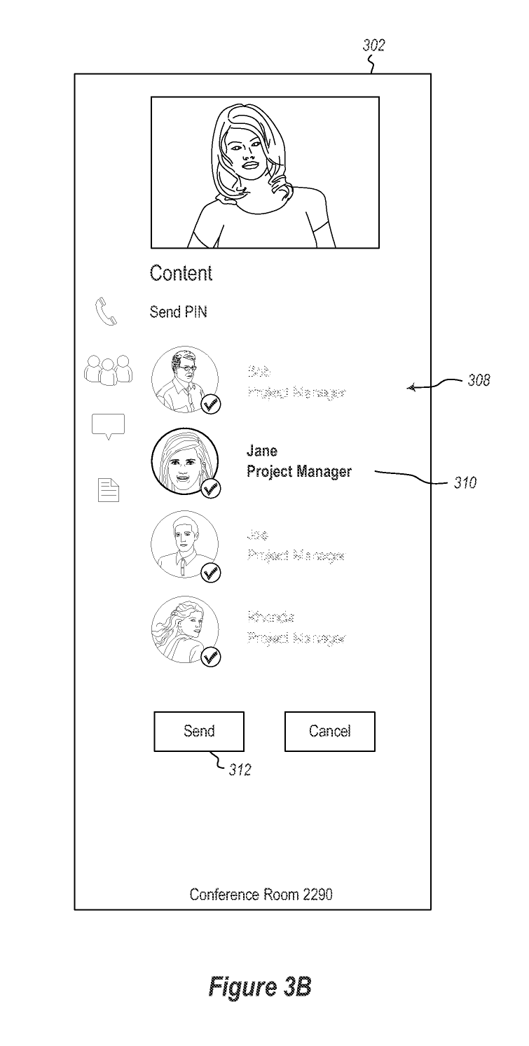

For example, reference is made to FIGS. 3A and 3B, which illustrates user interface elements that can be displayed in the user interface (see FIG. 1) of the communal device 108. In particular, FIG. 3A illustrates a content frame 302. The content frame 302 is configured to display shared content to meeting participants on the communal device 108. However, in the illustrated example, the communal device 108 blocks shared content from being displayed until an authentication token has been received from a user at the communal device. In particular, FIG. 3A illustrates that the content frame 302 includes a keypad 304. The keypad 304 allows the user 110-1 to enter a PIN at the communal device 108. Once correct key has been entered at the keypad 304, the content frame 302 displays shared content from the on-line meeting.

However, the user 110-1 may need a PIN to be sent to the user 110-1. As illustrated in FIG. 3A, the content frame 302 includes a button 306 that allows a user to initiate a PIN being sent to the user 110-1. When the user 110-1 selects the button 306, the content frame 302 is shown as illustrated in FIG. 3B. In particular, as illustrated in FIG. 3B, the content frame 302 includes a list 308 of the users that were invited to the on-line meeting. The user 110-1 can select one or more of the users from the list 308 to cause the communal device 108 to send a PIN from the communal device 108 to the users selected from the list 308. Thus, in the example illustrated in FIG. 3B, the user is selected as illustrated at 310, and the user 110-1 selects a send button 312 to cause an e-mail message including the token 112 to be sent to the user selected at 310. In particular, selecting the send button 312 in the content frame 302 causes the email client 120 to send an email 124 (see FIG. 2) to the user 110-1, which the user can obtain at the computing system 116.

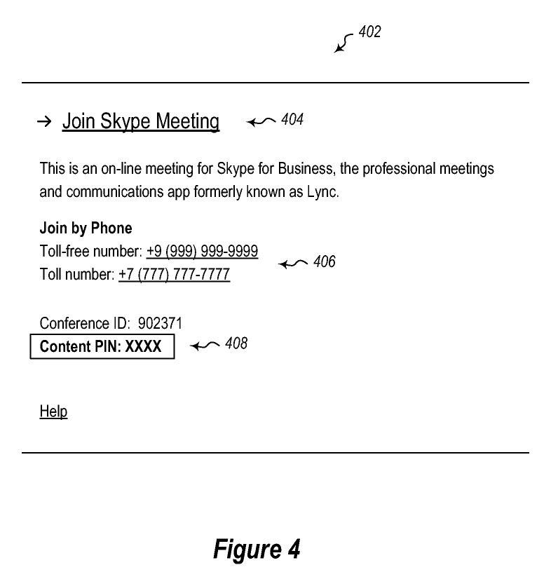

Illustrating now additional details, in some embodiments, the email server 114, such as Outlook available from Microsoft Corporation of Redmond, Wash., may include a plug-in to add a new property to a calendar invite that will be a token, such as a random four-digit PIN. In some embodiments, the token will be added to the text of the on-line meeting in the calendar item body and be available to users through the calendar item properties. For example, reference is now made to FIG. 4 which illustrates an example calendar invite 402. The calendar invite 402 includes a link 404 that the user can use to access the on-line meeting using their own computer system, a list 406 of one or more phone numbers the user can dial to connect to the on-line meeting by phone, and an identification 408 of a PIN that the user can use to access the on-line meeting from a communal device.

Embodiments may include functionality to implement various alternatives with respect to protecting content for an on-line meeting. For example, in some embodiments, the on-line meeting may be established as a locked meeting. For a locked meeting, in the illustrated embodiment, the content panel button 314 (see FIG. 3) is disabled until the communal device is admitted from the lobby.

For an unlocked, meeting, whether the security token 112 is required may be controlled using a specialized, setting. In the examples illustrated herein, this is illustrated as a RequireContentPIN policy setting. Note that in the illustrated embodiment, this is a per-account setting

One embodiment has three alternative values for this setting 1) content token is never required; 2) (note that this is the default value for some embodiments) content token is required outside of the time range of the scheduled meeting (for example, if a meeting is scheduled from 10:00-11:00 AM, the token is not required from 10:00-11:00 AM, but it is required at all other times.); and 3) content token is always required.

Some embodiments display the token entry screen illustrated in FIG. 3A when a user is not authorized to see the content. A user becomes authorized when: the communal device 108 is admitted from the lobby in a locked on-line meeting; when the policy setting is set to never require a token; when the policy setting is set to a schedule-based setting and the current communal device session overlaps the interval of the current calendar context; and/or after a user enters a valid token.

A user can become de-authorized for various reasons. For example, a user becomes de-authorized when: calendar context changes; a communal device session suspends and is then resumed; a user ends the communal device session. When a user is de-authorized, the authorization rules must be re-evaluated

The following illustrate some specific scenarios where these rules may apply. If the user hangs up and rejoins the online meeting within the same communal device session, she is still authorized. If the user ends a communal device session and clicks the same meeting from certain screens, such as a welcome screen, she is de-authorized, as this is a new communal device session. Within one communal device session, if the user hangs up an on-line meeting and joins a different meeting, the user is de-authorized, as this is a calendar context change. If a communal device session suspends and is later restored, the user is de-authorized.

The following now illustrates details with respect to the token entry screen illustrated in FIG. 3A. There are various different variations of this screen where the text changes and the PIN entry controls may be hidden.

For example in a first example, embodiments may retrieve a token from meeting properties at an email server. In this case, the title and description of the token entry screen are oriented toward telling the user to find the token in the meeting details. The token entry controls (e.g., the keypad 304) are displayed,

In a second example, embodiments do not retrieve a token from the email server's meeting properties (e.g., no web service connection or there is no token in the meeting properties). In this case, the title and description of the token entry screen tell the user that they need a token. The token entry controls are displayed.

In yet another example, the communal device 108 can generate and send a token as illustrated above. In this case, the title and description of the token entry screen tell the user to enter the token that they received. Token entry controls are displayed.

As illustrated in FIG. 3A, the screen displays a keypad (or other token entry mechanism such as a keyboard) on a touchscreen so that the user can enter the token and press the “OK” button 316. The “Clear” button 318 will delete any numbers entered up to this point.

The “Need a PIN” button 306 allows the user to receive an email with the token (in this case a PIN). If the token is in email server message properties, embodiments can simply send the same token. If not, the communal device 108 can generate a token for this meeting and send it.

When the user presses the “OK” button, the communal device 108 can check that the token is correct. In particular, the communal device includes a comparator 126 that the communal device can use to compare the token entered by the user with the known token (either generated by the communal device 108 or received from the email server 114).

If the entered token is not correct, the communal device 108 will display an error message. This error text may be proactively narrated so that users have the correct screen reader experience. The user will need to clear the token field 320 and try again; when the token is cleared, embodiments may hide the error message.

If the token is correctly entered by the user, the communal device removes the token entry screens and displays the content panel.

Embodiments may allow for an attached keyboard to be used in place of a touch screen. For example, a keyboard user can easily enter the token from the keyboard by setting focus in the token field 320. If the user hits “Enter” while focus is in the token field 320, this is equivalent to pressing “OK” button 316.

If the various components are in a state that the communal device 108 knows that sending email will not work, the communal device 108 will display an error message on the screen and not allow the user to attempt to send. For example, the communal device could display the following message: “Your device isn't set up for email. Please contact your support team.”

As noted above, the user can send the token for a particular on-line meeting to an email address that was on the original invite for the meeting. Thus, as illustrated in FIG. 3B, the user is only allowed to select from original invitees to select an individual to whom the token will be sent. If the token is in email server properties, embodiments (re)send that token. If the token is not in the email server properties, the communal device 108 generates a token for this meeting and. sends it to one or more selected users. The token generated will become the token for this meeting on this device (i.e., the communal device). It will be used for all interactions for this meeting and another token will never be generated for this meeting on this device. Alternatively, tokens may be generated on a per meeting, per device, per session basis. In this case, if a user ends a session, but wishes to rejoin the meeting, the user may need to request a new token.

As illustrated in FIG. 3B, the communal device 108 displays the list of invitees from the calendar item who got the original email invite for the particular on-line meeting. The user must select one of these addresses and cannot send to any other email address.

For each email address, some embodiments try to resolve the email address into a friendly name. Each item in the list 308, in the illustrated example, includes: a photo or generic avatar and a display name and/or the email address.

If this meeting has been marked as private, the list 308 will only contain the organizer's information and not information about other people invited to the meeting. Users will then need to obtain the token from the organizer.

Because the vast majority of meetings do not involve a communal device, embodiments may be implemented where the token is only in the calendar item body text only when a communal device is invited to the meeting (if at such embodiments, when scheduling a new meeting: at the time that the user sends the invite, if a communal device is invited, the calendar item may include the token. If a communal device is not invited, it will not include the token. When editing a meeting that was previously sent, if the user adds a communal device account, the calendar item can be updated to include the token. When editing a meeting that was previously sent, if the user removes a communal device account, the calendar item will not include the token.

In some embodiments, the token may be created by creating a random or pseudo random 4-digit number that is generated and added to the body text. In some embodiments, the function used to generate the number is a secure random number generation method. In some such embodiments, pseudo random number generators are not allowed. The token does not need to be unique, but should not be easily guessable. In some embodiments, the token will be generated such that it is not the same for all meetings scheduled by the same person (therefore cannot be related to the user's public meeting coordinates or conference ID) or with the same communal device account. The token may be stored as a property on a particular on-line meeting in the email server 112 (similar to how other meeting properties are stored).

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

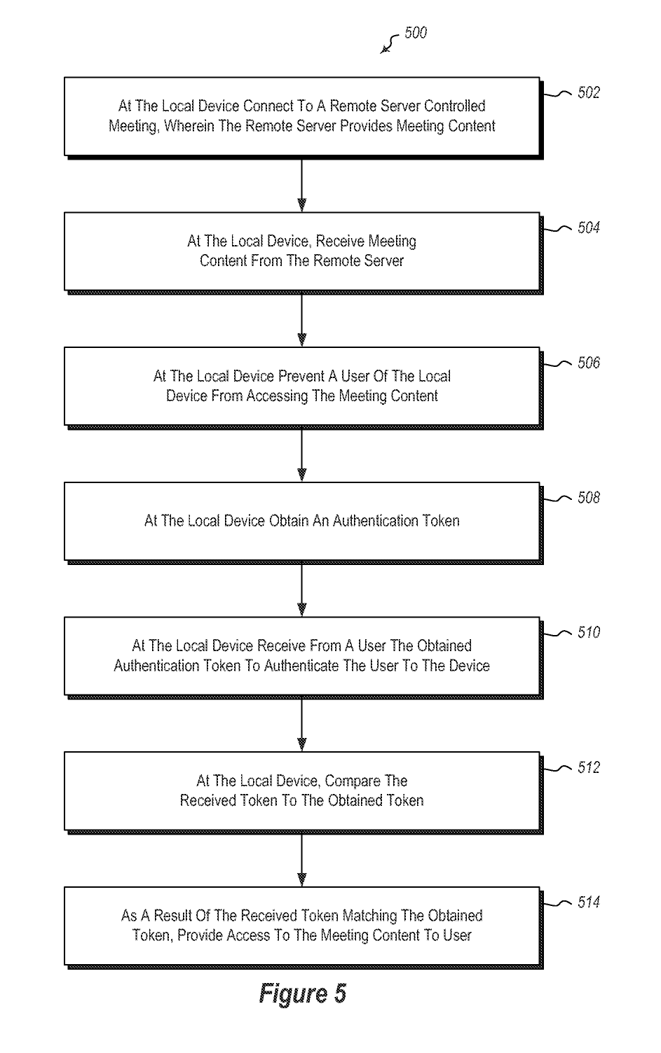

Referring now to FIG. 5, a method 500 is illustrated. The method 500 may be practiced in a content sharing environment. The method 500 includes acts for protecting content on a local device. The method 500 includes, at the local device connecting to a remote server controlled meeting, wherein the remote server provides meeting content (act 502).

The method 500 further includes, at the local device, receiving meeting content from the remote server (act 504).

The method 500 further includes, at the local device preventing a user of the local device from accessing the meeting content (act 506)

The method 500 further includes, at the local device obtaining an authentication token (act 508).

The method 500 further includes, at the local device receiving from a user the obtained authentication token to authenticate the user to the device (act 510). In particular, the user authenticates to the local device and not the on-line meeting itself.

The method 500 further includes, at the local device, comparing the received token to the obtained token (act 512).

The method 500 further includes, as a result of the received token matching the obtained token, providing access to the meeting content to user (act 514).

The method 500 may be practiced where the meeting content is meeting detail content. For example, the meeting detail content may be a meeting subject line, a meeting agenda, attachments, meeting invitees, etc.

The method 500 may further include the local device sending the authentication token to the user. In some embodiments, this may be done as a result of the user indicating that the token should be sent to them. In some such embodiments, the user is only able to select themselves from a list provided by the device, where the list includes meeting invitees. Thus, for example FIG. 3B illustrates an example where a list 308 of invitees is provided from which a user can select an invitee to send a token.

The method 500 may be practiced where the local device obtains the token from a server and the server provides the token to the user. For example, a token may be included in a meeting invite.

The method 500 may be practiced where the local device obtains the token by randomly generating the token at the device.

The method 500 may be practiced where the token is generated by the device on a per meeting, per session basis.

The method 500 may be practiced where the token is provided to the user by one or more of text, automated phone call or push notification on an app. In some embodiments, the token may be provided to the various modalities based on an invitees email address being associated with (such as in a contact) the other modalities, such as IM, text, phone number application user account.

The method 500 may further include consulting a token requirement policy to determine if token is needed. Thus, for example, as illustrated above, the token requirement policy may specify if a token is never needed, always needed, or only sometimes needed.

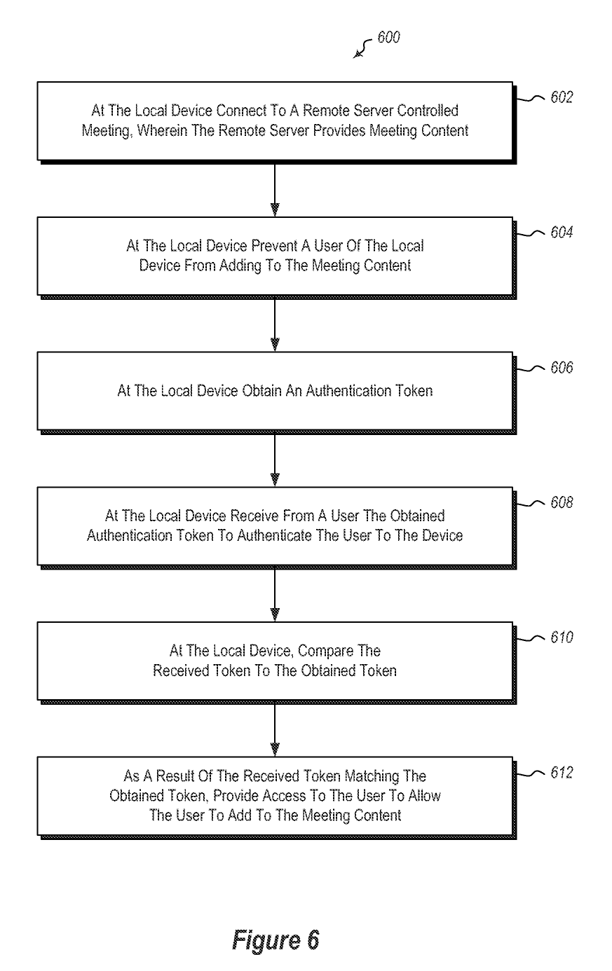

Referring now to FIG. 6, another method 600 is illustrated. The method 600 may be practiced in a content sharing environment. The method includes acts for protecting content on a local device. The method 600 includes at the local device connecting to a remote server controlled meeting, wherein the remote server provides meeting content (act 602).

The method further includes, at the local device preventing a user of the local device from adding to the meeting content (act 604).

The method further includes, at the local device obtaining an authentication token (act 606).

The method further includes, at the local device receiving from a user the obtained authentication token to authenticate the user to the device (act 608).

The method further includes, at the local device, comparing the received token to the obtained token (act 610).

The method farther includes, as a result of the received token matching the obtained token, providing access to the user to allow the user to add to the meeting content (act 612). Thus, in this example, a user is prevented from adding meeting content to an on-line meeting until the user is authenticated to the device, even though the device could itself add meeting content to the on-line meeting without restriction.

The method 600 may further include the local device sending the authentication token to the user.

The method 600 may be practiced where the local device obtains the token from a server and the server provides the token to the user.

The method 600 may be practiced where the local device obtains the token by randomly generating the token at the local device.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

“network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a content sharing environment, a method of protecting content on a local device, the method comprising:
at the local device connecting to a remote server controlled meeting, wherein the remote server provides meeting content;
at the local device, receiving meeting content from the remote server;
at the local device preventing a user of the local device from accessing the meeting content;
at the local device obtaining an authentication token;
at the local device receiving from a user the obtained authentication token to authenticate the user to the device;
at the local device, comparing the received token to the obtained token; and
as a result of the received token matching the obtained token, providing access to the meeting content to user.

2. The method of claim 1, wherein the meeting content is meeting detail content.

3. The method of claim 1 further comprising the local device sending the authentication token to the user.

4. The method of claim 1, wherein the local device obtains the token from a server and the server provides the token to the user.

5. The method of claim 1, wherein the local device obtains the token by randomly generating the token at the device.

6. The method of claim 1, wherein the token is generated by the local device on a per meeting, per session basis.

7. The method of claim 1, wherein the token is provided to the user by one or more of IM, text, automated phone call or push notification on an app.

8. The method of claim 1, further comprising consulting a token requirement policy to determine if token is needed.

9. In a content sharing environment, a system for protecting content on a local device, the system comprising:
one or more processors; and
one or more computer-readable media having stored thereon instructions that are executable by the one or more processors to configure the computer system to protect meeting content, including instructions that are executable to configure the computer system to perform at least the following:
at the local device connect to a remote server controlled meeting, wherein the remote server provides meeting content;
at the local device, receive meeting content from the remote server;
at the local device prevent a user of the local device from accessing the meeting content;
at the local device obtain an authentication token;
at the local device receive from a user the obtained authentication token to authenticate the user to the device;
at the local device, compare the received token to the obtained token; and
as a result of the received token matching the obtained token, provide access to the meeting content to user.

10. The system of claim 9, wherein the meeting content is meeting detail content.

11. The system of claim 9, wherein the one or more computer-readable media further have stored thereon instructions that are executable by the one or more processors to configure the computer system to cause the local device to send the authentication token to the user.

12. The system of claim 9, wherein the local device obtains the token from a server and the server provides the token to the user.

13. The system of claim 9, wherein the local device obtains the token by randomly generating the token at the device.

14. The system of claim 9, wherein the token is generated by the device on a per meeting, per session basis.

15. The system of claim 9, wherein the token is provided to the user by one or more of IM, text, or push notification on an app.

16. The system of claim 9, wherein the one or more computer-readable media further have stored thereon instructions that are executable by the one or more processors to configure the computer system to consult a token requirement policy to determine if token is needed

17. In a content sharing environment, a method of protecting content on a local device, the method comprising:
at the local device connecting to a remote server controlled meeting, wherein the remote server provides meeting content;
at the local device preventing a user of the local device from adding to the meeting content;
at the local device obtaining an authentication token;
at the local device receiving from a user the obtained authentication token to authenticate the user to the device;
at the local device, comparing the received token to the obtained token; and
as a result of the received token matching the obtained token, providing access to the user to allow the user to add to the meeting content.

18. The method of claim 17, further comprising the local device sending the authentication token to the user.

19. The method of claim 17, wherein the local device obtains the token from a server and the server provides the token to the user.

20. The method of claim 17, wherein the local device obtains the token by randomly generating the token at the local device.
